(19) United States
(12) Patent Application Publication
(10) Pub. No.: US 2019/0160328 A1
(43) Pub. Date: May 30, 2019

(54) COLLAPSIBLE EXERCISE STEPPER

(71) Applicant: Chung-Fu Chang, Changhua County (TW)

(72) Inventor: Chung-Fu Chang, Changhua County (TW)

(21) Appl. No.: 15/962,019

(22) Filed: Apr. 25, 2018

(30) Foreign Application Priority Data
Nov. 28, 2017 (CN) 201721619843.5
Jan. 15, 2018 (CN) 201820060469.8

(51) Int. Cl. A63B 22/00; A63B 21/008; A63B 21/00; A61H 7/00

(52) U.S. Cl. CPC A63B 22/0056; A63B 21/0083; A63B 21/4034; A63B 21/4035; A61H 2205/12; A63B 2210/50; A61H 2201/1261; A61H 2201/164; A61H 2201/1692; A61H 7/002

(57) ABSTRACT

A collapsible exercise stepper contains: a base, a movable extension rack, a grip assembly, two stepping units, two hydraulic cylinders, and a folding unit. The base includes a first fixing rod and a first connection rod, and the first fixing rod has a first coupling portion. The movable extension rack includes a second fixing rod and a second connection rod with a second coupling portion and two extending tabs, wherein the second connection rod has a horizontal bar and a third coupling portion. The grip assembly rotatably includes a handle, a fitting tube, an accommodation portion, and an actuation seat. Each stepping unit includes a support plate and a pedal, wherein the support plate has a rotation portion and a driving portion. Each hydraulic cylinder includes a first joining portion and a second joining portion. The folding unit includes a first operation element and a second operation element.

### FIELD OF THE INVENTION

The present invention relates to a collapsible exercise stepper which is stored easily in a small size.

### BACKGROUND OF THE INVENTION

With reference to FIG. 1, a conventional collapsible exercise stepper 90 contains a first support rod 91, a connector 92 arranged on a rear side of the support rod 91, a second support rod 93 rotatably connected with the connector 92 by using a fixing bolt, a grip assembly 94 mounted on a top of the first support rod 91, a connection rod fixed on a bottom of the first support rod 91, two hydraulic cylinders 96 rotatably fitted on the connection rod, wherein two horizontal bars extend from two sides of the first support rod 91 respectively, the two hydraulic cylinders 96 are rotatable coupled with the two horizontal bars and two pedals individually.

However, the conventional collapsible exercise stepper 90 has defects as follows:

1. The first support rod 91 and the grip assembly 94 are locked by an adjustment screw, and the first support rod 91 is coupled with the grip assembly 94 by another adjustment screw 97, but the two adjustment screws 97 are removable easily.

2. After the two adjustment screws 97 are removable, it is inconvenient to acquire the other adjustment screws for replacing the two adjustment screws 97.

The present invention has arisen to mitigate and/or obviate the afore-described disadvantages.

### SUMMARY OF THE INVENTION

The primary aspect of the present invention is to provide a collapsible exercise stepper which is simplified and is connected securely.

Another aspect of the present invention is to provide a collapsible exercise stepper which is stored easily in a small size.

To obtain the above aspects, a collapsible exercise stepper provided by the present invention contains: a base, a movable extension rack, a grip assembly, two stepping units, two hydraulic cylinders, and a folding unit.

The base includes a first fixing rod and a first connection rod connected on the first fixing rod, the first fixing rod has a first coupling portion extending from a bottom thereof, the first connection rod has a first connector extending from a first side thereof, and the first connection rod has a second connector extending from a second side thereof opposite to the first side of the first connection rod.

The movable extension rack includes a second fixing rod and a second connection rod connected on the second fixing rod, the second fixing rod has a second coupling portion and two extending tabs adjacent to the two ends of the second fixing rod individually, the second connection rod has a horizontal bar inserted through a lower end thereof and a third coupling portion arranged on an upper end of the second connection rod, wherein the third coupling portion is rotatably connected with the first connector by way of a first bolt element so that the movable extension rack is rotatably coupled on the base.

The grip assembly is rotatably connected with and is erected on a top of the base so as to be held by user's hands, the grip assembly includes a handle and a fitting tube on which the handle is mounted, the grip assembly includes an accommodation portion and an actuation seat, wherein the handle is accommodated in the accommodation portion, and the actuation seat is rotatably connected with the second connector by using a second bolt element so that the grip assembly is rotatably retracted relative to the base.

Each of the two stepping units includes a support plate and a pedal, the support plate has a rotation portion formed on a front end thereof and rotatably connected with the horizontal bar of the movable extension rack, the pedal is disposed on the support plate, and the support plate has a driving portion coupling with each of the two hydraulic cylinders.

Each of the two hydraulic cylinders includes a first joining portion and a second joining portion opposite to the first joining portion, the first joining portion is rotatably connected with the two extending tabs of the movable extension rack, and the second joining portion is rotatably coupled with the driving portion of the support plate.

The folding unit includes a first operation element and a second operation element, wherein the first operation element is rotatably joined with the first coupling portion of the first fixing rod, and the second operation element is rotatably joined with the second coupling portion of the second fixing rod, such that an expansion angle and an extending distance between the base and the movable extension rack are limited.

Preferably, the first fixing rod has two first anti-slip sleeves fitted on two ends of the first fixing rod respectively, and the second fixing rod has two second anti-slip sleeves fitted on two ends of the second fixing rod respectively.

Preferably, the base and the movable extension rack are expanded to erect on a ground.

Preferably, the grip assembly has an internal tube, an external tube in which the internal tube is housed, multiple orifices defined on the internal tube and the external tube so that a positioning bolt is accommodated in two corresponding orifices of the internal tube and the external tube.

Preferably, the pedal has multiple massage bosses formed thereon.

Preferably, the first operation element and the second operation element are connected by using an affix sheet and are retracted or expanded via a shaft.

Preferably, a limitation portion is arranged on the first operation element or the second operation element so that when the folding unit is expanded, and the limitation portion limits an expansion of the first operation element or the second operation element.

Preferably, the folding unit is folded in half with a movement of the movable extension rack.

Preferably, the movable extension rack further includes a fastener configured to fasten the base with the movable extension rack.

Preferably, the first operation element and the second operation element are a rope, wherein the first operation element is connected with the first coupling portion of the first fixing rod by using a hook on an end of the first operation element, and the second operation element is coupled with the second coupling portion of the second fixing rod by way of another hook on an end of the second operation element.

Preferably, the grip assembly is rotatably connected with and is erected on the base by way of the second connector, the actuation seat, and a locking unit.

Preferably, the locking unit is a quick release element or a screw bolt.

### BRIEF DESCRIPTION OF THE DRAWINGS

FIG. 1 is a schematic view of a conventional collapsible exercise stepper.

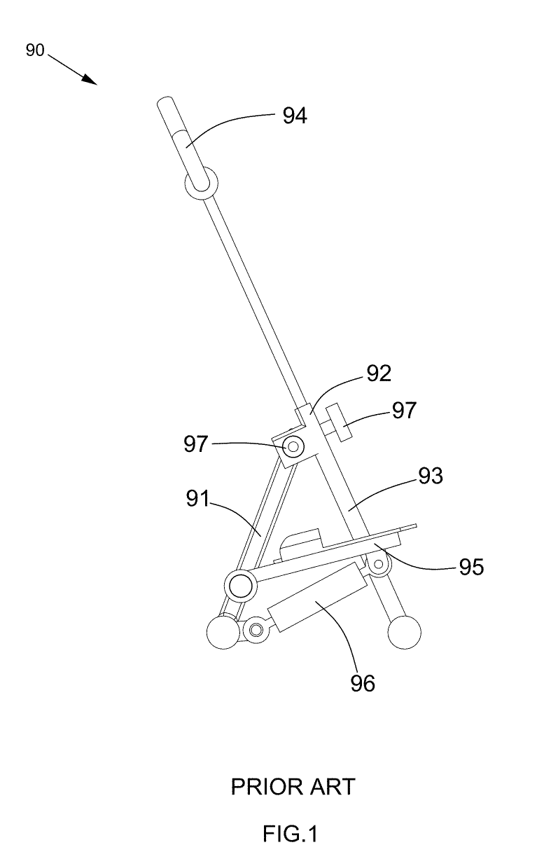

FIG. 2 is a perspective view showing the assembly of a collapsible exercise stepper according to a first embodiment of the present invention.

FIG. 3 is another perspective view showing the assembly of the collapsible exercise stepper according to the first embodiment of the present invention.

FIG. 4 is a perspective view showing the exploded components of the collapsible exercise stepper according to the first embodiment of the present invention.

FIG. 5 is a side plan view showing the assembly of a part of the collapsible exercise stepper according to the first embodiment of the present invention.

FIG. 6 is a side plan view showing the assembly of the collapsible exercise stepper according to the first embodiment of the present invention.

FIG. 7 is a side plan view showing the operation of the collapsible exercise stepper according to the first embodiment of the present invention.

FIG. 8 is a perspective view showing the operation of the collapsible exercise stepper according to the first embodiment of the present invention.

FIG. 9 is a side plan view showing the assembly of a part of a collapsible exercise stepper according to a second embodiment of the present invention.

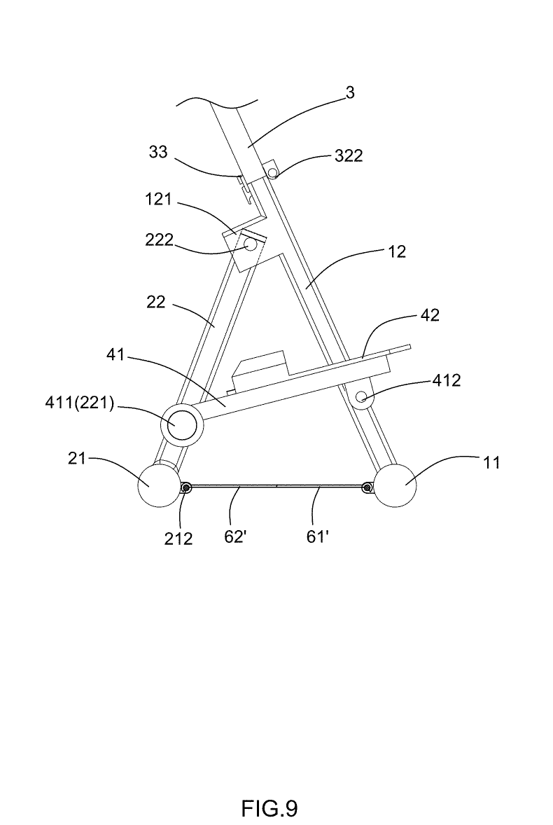

### DETAILED DESCRIPTION OF THE PREFERRED EMBODIMENTS

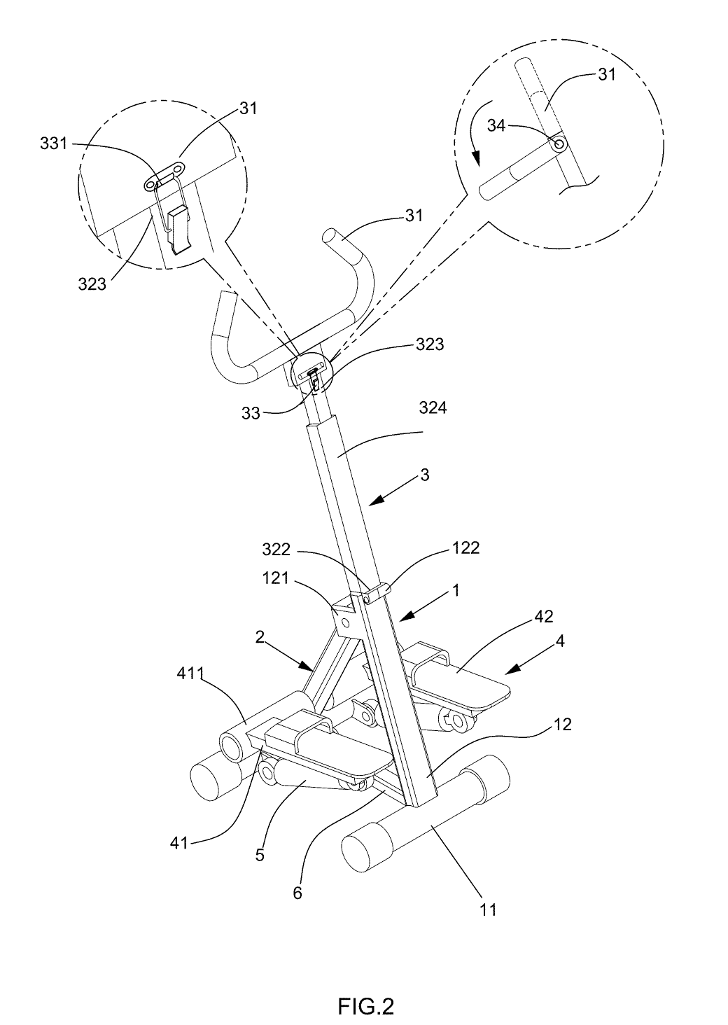

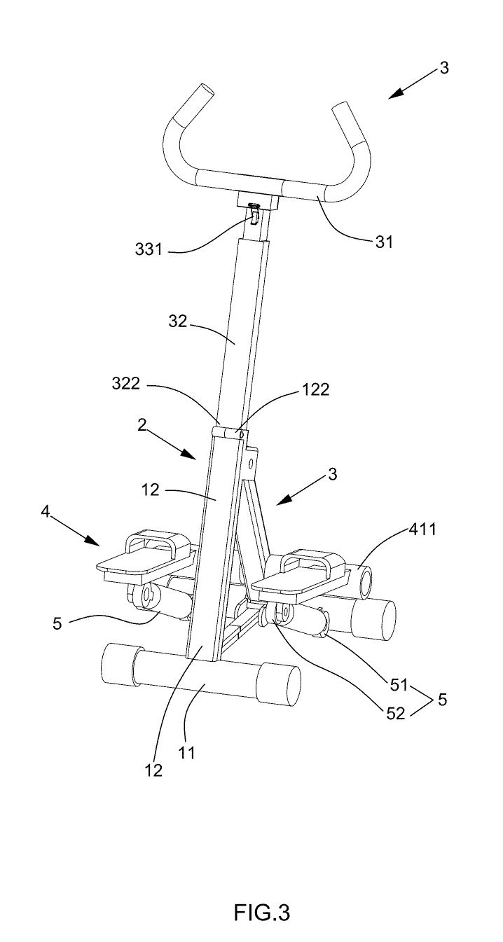

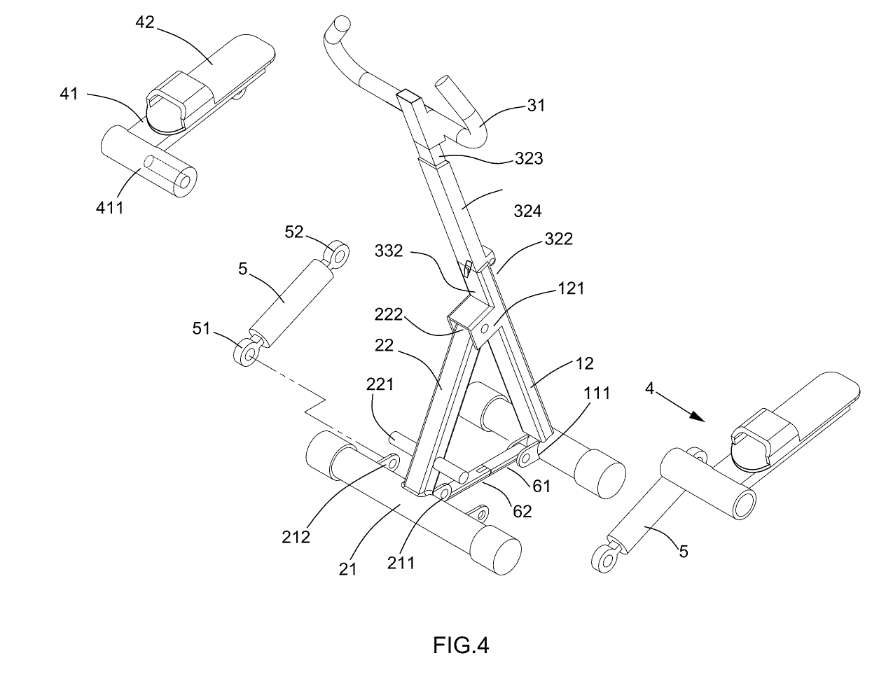

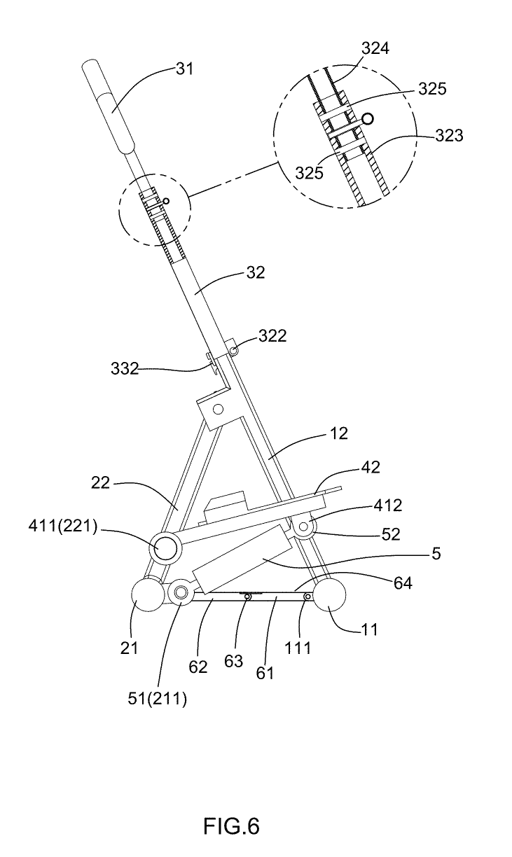

With reference to FIGS. 2-6, a collapsible exercise stepper according to a first embodiment of the present invention comprises: a base 1, a movable extension rack 2, a grip assembly 3, two stepping units 4, two hydraulic cylinders 5, and a folding unit 6.

The base 1 includes a first fixing rod 11 and a first connection rod 12 connected on the first fixing rod 11, wherein the first fixing rod 11 has a first coupling portion 111 extending from a bottom thereof and two first anti-slip sleeves fitted on two ends of the first fixing rod 11 respectively. The first connection rod 12 has a first connector 121 extending from a first side thereof, and the first connection rod 12 has a second connector 122 extending from a second side thereof opposite to the first side of the first connection rod 12.

The movable extension rack 2 is rotatably connected with the base 1 so that the base 1 and the movable extension rack 2 are expanded to erect on a ground. The movable extension rack 2 includes a second fixing rod 21 and a second connection rod 22 connected on the second fixing rod 21, wherein the second fixing rod 21 has a second coupling portion 211 extending therefrom, two second anti-slip sleeves fitted on two ends of the second fixing rod 21 respectively, and two extending tabs 212 adjacent to the two ends of the second fixing rod 21 individually. The second connection rod 22 has a horizontal bar 221 inserted through a lower end thereof and a third coupling portion 222 arranged on an upper end of the second connection rod 22, wherein the third coupling portion 222 is rotatably connected with the first connector 121 by way of a first bolt element so that the movable extension rack 2 is rotatably coupled on the base 1.

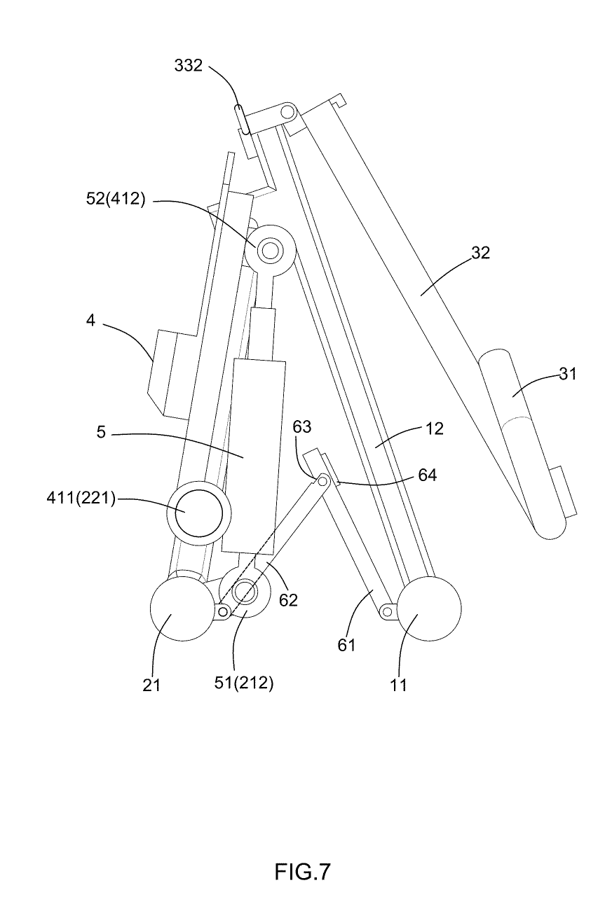

The grip assembly 3 is rotatably connected with and is erected on a top of the base 1 so as to be held by user's hands. The grip assembly 3 includes a handle 31 and a fitting tube 32 on which the handle 31 is mounted. The grip assembly 32 includes an accommodation portion 321 and an actuation seat 322, wherein the handle 31 is accommodated in the accommodation portion 321, and the actuation seat 322 is rotatably connected with the second connector 122 by using a second bolt element so that the grip assembly 3 is rotatably retracted relative to the base 1. Referring to FIGS. 2-7, the grip assembly 32 has an internal tube 323, an external tube 324 in which the internal tube 323 is housed, multiple orifices 325 defined on the internal tube 323 and the external tube 324 so that a positioning bolt is accommodated in two corresponding orifices 325 of the internal tube 323 and the external tube 324, thus fixing a height of the internal tube 323 and the external tube 324 based on using requirements.

Each of the two stepping units 4 includes a support plate 41 and a pedal 42, wherein the support plate 41 has a rotation portion 411 formed on a front end thereof and rotatably connected with the horizontal bar 221 of the movable extension rack 2, and the pedal 42 is disposed on the support plate 41. The support plate 41 also has a driving portion 412 coupling with each of the two hydraulic cylinders 5. In another embodiment, the pedal 42 has multiple massage bosses formed thereon so as to massage user's sole and to promote blood circulation.

Each hydraulic cylinder 5 includes a first joining portion 51 and a second joining portion 52 opposite to the first joining portion 51, wherein the first joining portion 51 is rotatably connected with the two extending tabs 212 of the movable extension rack 2, and the second joining portion 52 is rotatably coupled with the driving portion 412 of the support plate 41.

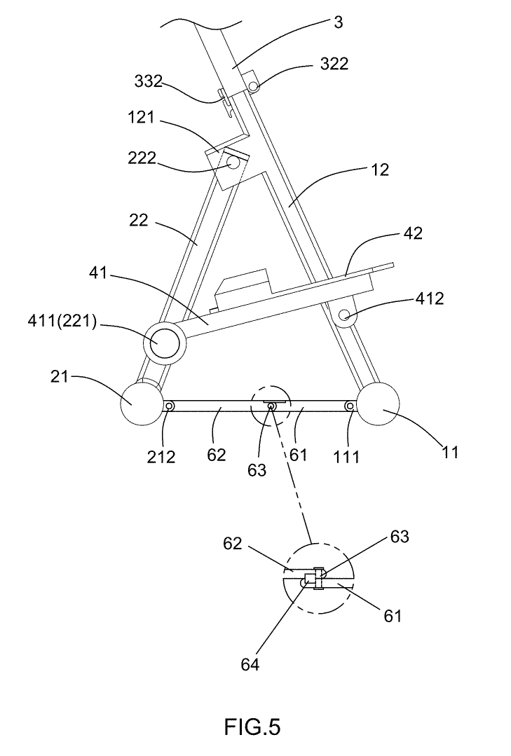

The folding unit 6 includes a first operation element 61 and a second operation element 62, wherein the first operation element 61 is rotatably joined with the first coupling portion 111 of the first fixing rod 11, and the second operation element 62 is rotatably joined with the second coupling portion 211 of the second fixing rod 21, such that an expansion angle and an extending distance between the base 1 and the movable extension rack 2 are limited. As shown in FIGS. 5-7, the first operation element 61 and the second operation element 62 are connected by using an affix sheet and are retracted or expanded via a shaft 63, wherein a limitation portion 64 is arranged on the first operation element 61 or the second operation element 62 so that when the folding unit 6 is expanded, the limitation portion 64 limits an expansion of the first operation element 61 or the second operation element 62.

In operation, the movable extension rack 2 is pulled relative to the base 1 so that the base 1 and the movable extension rack 2 are erected on the ground, and the folding unit 6 is expended. Then, the grip assembly 3 is rotatably connected with and is erected on the base 1 by way of the second connector 122, the actuation seat 322, and a locking unit 33. The locking unit 33 is a quick release element or a screw bolt. Accordingly, user steps the pedal 42 of each stepping unit 4 so that each stepping unit 4 rotates along the horizontal bar 221, and each hydraulic cylinder 5 is pressed by the pedal 42 so as to push against the pedal 42 upward, thus stepping the pedal 42 repeatedly. Thereby, the collapsible exercise stepper is simplified and is connected securely.

After rotating each stepping unit 4 upwardly, the second joining portion 52 of each hydraulic cylinder 5 lifts, and the grip assembly 3 is retracted to the base 1. Thereafter, the folding unit 6 is folded in half with a movement of the movable extension rack 2. The movable extension rack 2 further includes a fastener configured to fasten the base 1 with the movable extension rack 2, thus retracting the collapsible exercise stepper easily and quickly.

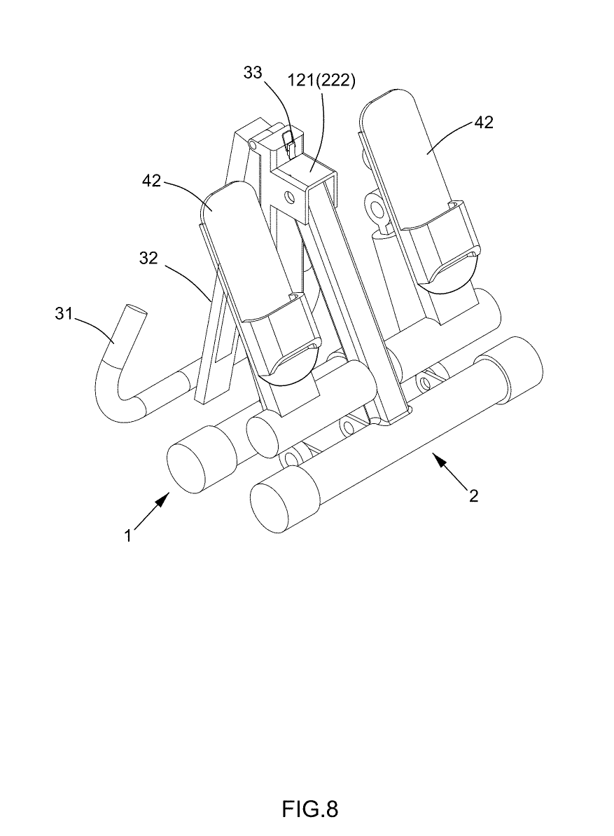

As illustrated in FIG. 8, in another embodiment, a first operation element 61′ and a second operation element 62′ are a rope, wherein the first operation element 61′ is connected with the first coupling portion 111 of the first fixing rod 11 by using a hook 63′ on an end of the first operation element 61′, and the second operation element 62′ is coupled with the second coupling portion 211 of the second fixing rod 21 by way of another hook 63′ on an end of the second operation element 62′, thus expending or retracting the collapsible exercise stepper easily and quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention

What is claimed is:

1. A collapsible exercise stepper comprising: a base, a movable extension rack, a grip assembly, two stepping units, two hydraulic cylinders, and a folding unit;
the base including a first fixing rod and a first connection rod connected on the first fixing rod, the first fixing rod having a first coupling portion extending from a bottom thereof, the first connection rod having a first connector extending from a first side thereof, and the first connection rod having a second connector extending from a second side thereof opposite to the first side of the first connection rod;
the movable extension rack including a second fixing rod and a second connection rod connected on the second fixing rod, the second fixing rod having a second coupling portion and two extending tabs adjacent to the two ends of the second fixing rod individually, the second connection rod having a horizontal bar inserted through a lower end thereof and a third coupling portion arranged on an upper end of the second connection rod, wherein the third coupling portion is rotatably connected with the first connector by way of a first bolt element so that the movable extension rack is rotatably coupled on the base;
the grip assembly rotatably connected with and erected on a top of the base so as to be held by user's hands, the grip assembly including a handle and a fitting tube on which the handle is mounted, the grip assembly including an accommodation portion and an actuation seat, wherein the handle is accommodated in the accommodation portion, and the actuation seat is rotatably connected with the second connector by using a second bolt element so that the grip assembly is rotatably retracted relative to the base;
each of the two stepping units including a support plate and a pedal, the support plate having a rotation portion formed on a front end thereof and rotatably connected with the horizontal bar of the movable extension rack, the pedal being disposed on the support plate, and the support plate having a driving portion coupling with each of the two hydraulic cylinders;
each of the two hydraulic cylinders including a first joining portion and a second joining portion opposite to the first joining portion, the first joining portion being rotatably connected with the two extending tabs of the movable extension rack, and the second joining portion being rotatably coupled with the driving portion of the support plate; and
the folding unit including a first operation element and a second operation element, wherein the first operation element is rotatably joined with the first coupling portion of the first fixing rod, and the second operation element is rotatably joined with the second coupling portion of the second fixing rod, such that an expansion angle and an extending distance between the base and the movable extension rack are limited.

2. The collapsible exercise stepper as claimed in claim 1, wherein the first fixing rod has two first anti-slip sleeves fitted on two ends of the first fixing rod respectively, and the second fixing rod has two second anti-slip sleeves fitted on two ends of the second fixing rod respectively.

3. The collapsible exercise stepper as claimed in claim 1, wherein the base and the movable extension rack are expanded to erect on a ground.

4. The collapsible exercise stepper as claimed in claim 1, wherein the grip assembly has an internal tube, an external tube in which the internal tube is housed, multiple orifices defined on the internal tube and the external tube so that a positioning bolt is accommodated in two corresponding orifices of the internal tube and the external tube.

5. The collapsible exercise stepper as claimed in claim 1, wherein the pedal has multiple massage bosses formed thereon.

6. The collapsible exercise stepper as claimed in claim 1, wherein the first operation element and the second operation element are connected by using an affix sheet and are retracted or expanded via a shaft.

7. The collapsible exercise stepper as claimed in claim 6, wherein a limitation portion is arranged on the first operation element or the second operation element so that when the folding unit is expanded, and the limitation portion limits an expansion of the first operation element or the second operation element.

8. The collapsible exercise stepper as claimed in claim 1, wherein the folding unit is folded in half with a movement of the movable extension rack.

9. The collapsible exercise stepper as claimed in claim 1, wherein the movable extension rack further includes a fastener configured to fasten the base with the movable extension rack.

10. The collapsible exercise stepper as claimed in claim 1, wherein the first operation element and the second operation element are a rope, wherein the first operation element is connected with the first coupling portion of the first fixing rod by using a hook on an end of the first operation element, and the second operation element is coupled with the second coupling portion of the second fixing rod by way of another hook on an end of the second operation element.

11. The collapsible exercise stepper as claimed in claim 1, wherein the grip assembly is rotatably connected with and is erected on the base by way of the second connector, the actuation seat, and a locking unit.

12. The collapsible exercise stepper as claimed in claim 1, wherein the locking unit is a quick release element or a screw bolt.
